(19) United States
(12) Patent Application Publication
(10) Pub. No.: US 2002/0118231 A1
(43) Pub. Date: Aug. 29, 2002

(54) Method of realistically displaying and interacting with electronic files

(76) Inventors: Jeff Smith, Calgary (CA); Prasad Maruvada, Newmarker (CA); Dale Darling, Toronto (CA); Bryan Joyce, Mississauga (CA); Magdin Stoica, Campbellville (CA)

Correspondence Address: PATENT ADMINSTRATOR, KATTEN MUCHIN ZAVIS, SUITE 1600, 525 WEST MONROE STREET, CHICAGO, IL, 60661, US

(21) Appl. No.: 09/987,425

(22) Filed: Nov. 14, 2001

Related U.S. Application Data
(60) Provisional application No. 60/247,909, filed on Nov. 14, 2000.

(51) Int. Cl. G09G 5/00

(52) U.S. Cl. 345/806

(57) ABSTRACT

The present application provides a software architecture having a framework and extensibility of that framework. The framework is the foundation for all of the components that implement the core functionality. Software is developed by building a basic application, and adding components to it that implement the functionality of that application. Those components are extensible and flexible, so as to be reused in future products. The framework constitutes the portions of an application that are not covered by any one particular module. There are five general categories of components that constitute the Architecture Framework are Applications, Frame Windows, Documents, Extensions, and Services. A frame manager controls all frame windows used by an application with the help of and extension manager.

### FIELD OF THE INVENTION

The present invention relates to a method of realistically displaying and interacting with electronic files.

### BACKGROUND OF THE INVENTION

The desktop analogue for computer user interfaces has been has been popular since the mid 1980s. Both Microsoft Windows and Macintosh operating systems have successfully used this UI.

Over time computer users have adapted to the demands of the interfaces, which have become more powerful over time, but have also increased significantly in complexity. As the complexity has increased, the user interfaces have taken on their own look and feel that at times simulates the desktop, but at others follows their own format paradigm.

As a consequence, users have developed loyalties to particular user interfaces and are consequently very resistant to changes, even with the promise of greater functionality. This is particularly true in rapid turn over applications such as e-mail. With e-mail users have generally had to adapt their style of communications to suit the application being used. While the physicality of buttons and icons have evolved to a more ore less de facto standard, an individuals interaction with the particular user interface is still dictated by that interface to a large degree.

While sophisticated users have been able to evolve with these interfaces, those users who have only recently become exposed to these user interfaces may find significant challenges in relating easily to what is being displayed on screen. As a consequence, there is still a need to provide a more natural or realistic user interfac.

### SUMMARY OF THE INVENTION

An object of the present invention is to provide an improved method of displaying and interacting with electronic files.

Accordingly aspects of the present invention may include one or more of the following:

Active Display Signature Authentication;

Multi Window Natural Documentation Presentation;

Realistic Page Based Documents.

The embodiments of the invention have arisen out of and are related to processing of email. However, aspects of the invention set out herein are not restricted to email applications.

Advantageously, embodiments of the invention set out herein can be used to take a simple email text message and convert it into a virtual paper message in a multi window format, including envelope information, business cards, photographs and other such information as may be desired. Embodiments of the invention herein enriche the email environment making it more interesting and much closer to what people are used to seeing in written and printed communications in the real world.

### BRIEF DESCRIPTION OF THE DRAWINGS

The present invention will be further understood from the following detatiled description with reference to the drawings in which:

FIG. 1 illustrates in a dynamic diagram launching a single frame Metamail application in accordance with an embodiment of the present invention;

FIG. 2 illustrates in a block diagram the relationship of the Frame Manager to the Application and the frames in accordance with an embodiment of the present invention;

FIG. 3 illustrates in a dynamic diagram, a user launching a Metamail application with a single frame is created and presented to that user in accordance with an embodiment of the present invention;

FIG. 4 illustrates in a block diagram an exemplary relationship between application, frame manager and various frame windows;

FIG. 5 illustrates in a dynamic diagram the management of a single instance frame;

FIG. 6 illustrates a dependency diagram showing the Extension Manager's place in a Metamail application with two frames launched;

FIG. 7 illustrates in a dynamic diagram how the Extension Manager is ultimately responsible for all the Extension objects;

FIGS. 8 and 9 illustrate how the Extension Manager 50 should first check for the resource set for the given frame within the Resource Provider cache;

FIG. 10 illustrates in a block diagram the extension manager's handshaking mechanism;

FIG. 11 a dynamic diagram illustrates the command routing procedure; and

FIG. 12 illustrates the relationships between the user interface objects.

### DETAILED DESCRIPTION OF THE PREFERRED EMBODIMENT

The problem is to provide an active display signature that a user would recognize as coming from an individual. It must be usable and accessible to the common user. It must be easy to understand so that a degree of trust can be built up. It is not simply a digital signature but a metaphor for a signature that is easy to recognize and understand.

Embodiments of the invention utilize a bitmap of the actual written signature of the sender, however the bitmap is not used for authenticity purposes. What is needed is a programmatic interface that can't be spoofed by content. The software automatically deciphers the symbol that is sent and determines if it is authentic. A glyph or an indicator has to be presented in such a way that it cannot be spoofed by content. As an example, a ribbon or seal can be placed on the document if the signature is authentic. If it is not, the seal with an X through it or a circle and a bar through it can be used. The combination of an embedded signature glyph and active display iconography is used.

Embodiments of the present invention evolve the computer desktop to a multi window format as opposed to a single document in a window. A multi window format is more natural and simulates a physical desktop to a higher degree.

Applications that use more than one window are well known. However, in those known applications the document is only in one window. Embodiments of the invention present a document in multiple windows. For embodiments that are e-mail applications this leads to a “what you see is what was sent” paradigm. The present method results in the desktop being document organized instead of application organized. Consequently, the document runs the show. While the application is pulled in as necessary to act upon that portion of the document that is being worked on. The document is presented in multiple windows each window containing its own information flow organized into one document. In Unix, portable bitmap tools can be used so that one can scale, resize and use contrast and other methods.

This permits a form of piping to take place. A document is created and put through a pipe where it is filtered so it comes out looking very different then the text message that went in. The key is to know the file formats so one can modify it. All applications need to have the particular file format.

reverse OLE

imbed application

The embodiments of the present invention provide th windowing functionality as Microsoft Windows does not support it. A windowing environment had to be built within Microsoft Windows in order to display sub elements of a document in separate windows.

In accordance with an embodiment of the present invention, the metaphor for presentation of document information to use paging rather than scrolling. This supports the idea to use a natural paper look to get the look and feel of a real document. A paper texturizing technique was invented which used a special proprietary compression method. Showing paper texture, including logos, etc., is byte heavy or utilizes a great deal of storage or transmission capacity. The compressive technology set out in a copending application U.S. patent application Ser. No. 09/262,056 allows compression to a thousand times smaller than JPEG. It is also resolution independent whereas JPEG becomes very granular as one sizes up. JPEG can also do tiling but it is not very effective. This invention allows the production of virtual paper utilizing compressed textural data. For example, a typical Microsoft Power Point presentation is a huge information load, with 60 to 70% of that information being with respect to the background of the presentation. Typically, 50 to 70 megabytes of data gets compressed to approximately 5 megabytes in this application. The key is to be able to put different textures on virtual paper in other applications.

The various embodiments of the present invention are set out in more detail below.

The requirements of the Metamail software architecture (MSA) are described below:

Extensible: Products created using this architecture must be extendible as conveniently and flexibly as possible.

Convenient: Providing deep extensibility introduces levels of complexity that would normally be non-issues, so creation of products using this architecture must be as convenient as possible.

Timely: After an initially expensive design phase for the architecture, future products built with the architecture must be able to be produced in a timely fashion.

Simple: The architecture must be reasonably uncomplicated.

Clean: No compromises are to be made when designing the architecture. The above requirements should be met with little or no shortcuts.

This section describes the general overview of the MSA. This overview focuses on two major points: The Framework and the Extensibility of that Framework. The Framework is the foundation for all of the components that implement the core functionality of Metamail products. The complete extensibility of that Framework is the Metamail design goal.

About the Framework: This section gives a brief synopsis of the MSA Framework and identifies the major components.

Initializing the Framework: Once the major components have been identified, it is important to describe their connectivity and interoperability. This section illustrates the overall relationship between the major components.

Extending the Framework: This section gives a general overview on how to add feature functionality to the Frame Windows by using Extensions.

Metamail Software is developed by building a basic application, and adding components to it that implement the functionality of that application. Those components are extensible and flexible, so as to be reused in future products. The Framework constitutes the portions of a Metamail Application that are not covered by any one particular module. There are five general categories of components that constitute the Architecture Framework:

Applications

Frame Windows

Documents

Extensions

Services

The Framework can best be described as the binding of these components into a coherent system. The following section provides a general overview of the framework and describes how the major components are related and linked together.

Applications

A Metamail application is a small executable file that contains almost no functionality. Some of its basic duties include displaying splash screens (open and close if required) and checking for a previous instance of itself and activating it if a second instance is opened (i.e. Single Instance Application). Unlike a traditional MFC Application, which consists of the application instance, a main frame window and one or more document-view windows, a Metamail Application is comprised of an application instance and multiple Frame windows (not to be confused with the CFrameWnd in MFC). These frames encapsulate all of the UI that the end user recognizes as the complete Metamail application.

Frame Windows

Frame windows are windows that look and behave like MFC CFrameWnd windows or standalone applications. They have a resizable frame, a title bar, a menu, a toolbar and a main view. The UI may be such that the existence of these parts is not clearly visible, but the functionality is there. A Metamail application may require the creation, usage and management of several frame windows. To the end user, these frames represent the complete application.

In order for anyone create these frames, we require an object that is responsible for creating and managing all frames in the system. This object is the Frame Manager. The Frame Manager is initially created by the Main Application and is a singleton object accessible to all. The Frame Manager plays one of the most crucial roles in the system and is further discussed in the Initializing the Framework section.

Documents

At the core of each frame window is an object that maintains the basic identity of that frame. This object is called a document object (which, when referred to in the context of the frame window, is sometimes known as the document). This is similar to MFC's notion of a “document”, which encapsulates a specific type of data within an object.

Traditionally, the relationship between document and frame window is 1:1 however a frame window has the freedom to manage multiple document extensions if so desired.

Extensions

Each Metamail Application is installed with a suite of extensions. An extension is an add-on to an application that encapsulates a feature or set of functionality that will allow the end user to perform a specific task. Without these extensions, the application would provide no functionality.

Extensions can add a new feature or modify the behavior of existing features. As such, extensions have an obvious user-interface element, such as menus, toolbars, and Options dialogs. Extensions extend frame windows by inserting themselves into the user interface, giving users access to the extension's functionality. Essentially, a frame window builds itself by enumerating through all the extensions that are meant to extend it (specified in registry settings) and incorporating the extensions' functionality within itself. In order to do this each frame window creates an extension manager. The extension manager builds the frame window's toolbars and menus and manages the routing of those commands to the appropriate extensions. The extension manager's role is examined in more detail in the Extending the Framework section.

The Extension Manager is able to figure out which extensions extend the document and establish a connection between them. The extension will communicate and deal with the Doc through its provided interfaces. In some cases, the Docs may need to implement custom interfaces for a specific extension. Currently, Metamail extensions come in two flavors: Enhancement Extensions and View Extensions. View extensions are more complex extensions that are in charge of the application's user interface (See View Extension section for detail).

To integrate extensions into the user interface, a smart but simple system has been designed. It has been designed to make extension creation as easy as possible, with a slight loss of flexibility, when compared to similar architectures in other applications (such as Outlook). Since most Metamail applications will be implemented using extensions, the ease of creation became very important. The resulting system solves the expandability and version control problems without overburdening the Extension developer.

Services

A service is a utilitarian object or control that does not implement a specific feature, but provides functionality that is required by other services or extensions. The Frame Manager, for instance, provides the basic means for anyone to create a frame window while the Extension Manager provides these frame windows the means to manage extensions.

Initializing the Framework

Now that the major components have been identified, this section describes the starting point of how they all come together to form the framework. The purpose of this section is to illustrate the connections and dependencies between the major components in order for anyone to design and develop a Metamail application.

Launching the Main Application

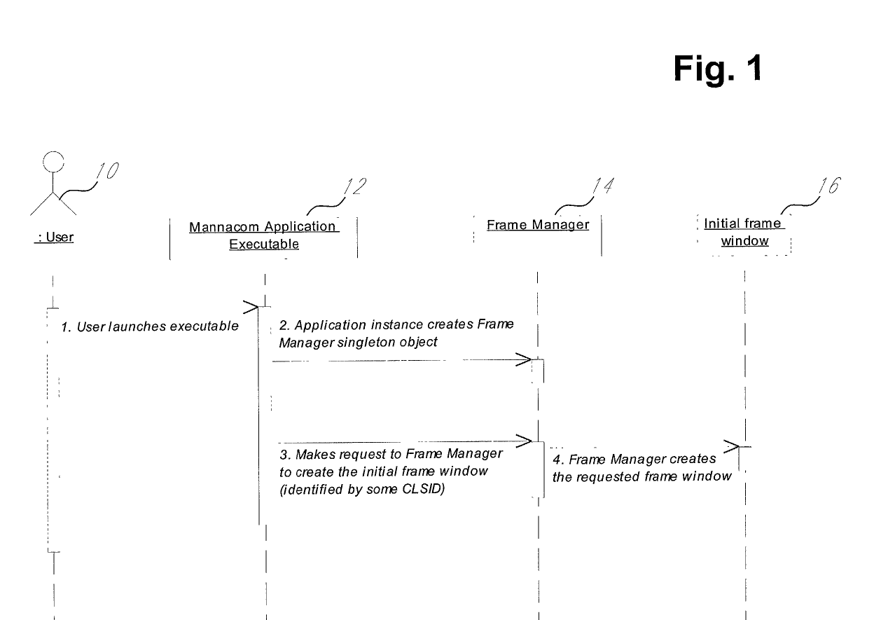

Referring to FIG. 1 there is illustrated in a dynamic diagram launching a single frame Metamail application in accordance with the present invention. A user 10 launches an executable (1) causing a Manacom application executable 12 to create a Frame Manager 14 singleton object (2) and requests the Frame Manager 14 to create an initial frame window (3). The Frame Manager 14 creates (4) the initial frame window 16.

A Metamail application cannot be compared to the conventional MFC frameworks that most developers are used to. Although we use familiar concepts such as frames and documents and even the same technology, a Metamail application need not be categorized as SDI or MDI or some hybrid of the two. Instead, the Metamail Framework Architecture has opted for a more flexible and less constrained approach to applications.

As described in the introductory sections, a Metamail application is a potentially small executable that consists of an application instance and one or more frame windows. To the end user these frames encapsulate all of the application's UI. Although a user may regard one of those frames as the “primary” or “main” frame that he/she deals with the most, technically there is no single frame window that represents the entire application.

The number and type of frames an application needs is entirely up to that specific Metamail application. A Metamail application can be represented by a single frame (perhaps to appear “SDI-ish”) or multiple frames. An application may use a frame that is rather simple in nature or extremely complex (e.g. a single frame that manages multiple documents perhaps . . . sounds “MDI-ish”). Although the creation of such frames is discussed in more detail in the Frame Window Creation section, it is important to point out that this approach is flexible and not constrained to labels.

Now the main application executable 12 cannot do all of the aforementioned feats alone. It needs some help to manage the creation and destruction of these frame windows. That help comes in the form of the Frame Manager 14. The Frame Manager 14 singleton COM object is a crucial service in a Metamail designed system and is one of the very first objects that a Metamail application creates at startup.

Frame Manager Overview

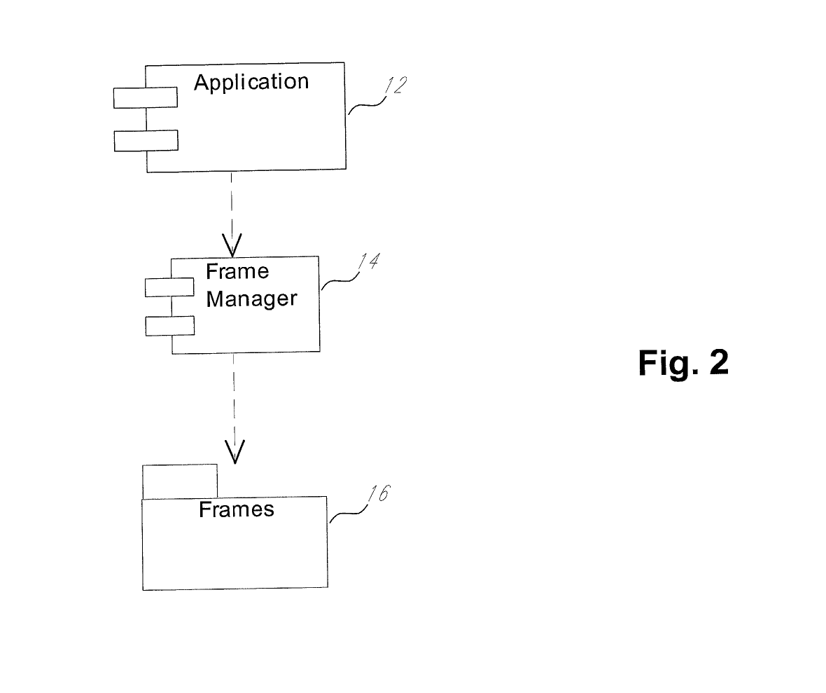

The Frame Manager is a singleton object initially created by a Metamail application instance. Referring to FIG. 2 there is illustrated in a block diagram the relationship of the Frame Manager to the Application and the frames. The Application 12 instantiates the Frame Manager 14, which in turn instantiates the frame windows 16 used by the application.

All creation and destruction of frame windows 16 is done through the Frame Manager object 14. Some of its major functional requirements include:

Instantiating Frame Windows.

Keeping track of Frame window creation and destruction.

Shutdown main application executable when all frames are closed.

Keeping track of Frame Windows with unique identifiers so as to re-activate them should a request be made to open a similar frame with the same identifier.

This allows Metamail applications to treat their frames as “single instance” (i.e. like trying to open a Word doc twice from within MS Word or the same message twice from within Outlook).

The life cycle of a frame window is far from trivial since a Metamail application may allow the user tremendous freedom when it comes to managing the various frames. In the simplest case a user launches the application which presents the user with an initial Frame window. However, an extreme use case scenario may involve the launching a Metamail application, being presented with multiple initial frame windows, and allowing the user to spawn several other frame windows through interaction with the initial frames. As a result the Frame Manager must be prepared to handle these and other equally complicated scenarios.

Frame Window Creation

One of the main functional requirements of the Frame Manager is to create Frame windows. A Frame Window is a COM object, which any client can create through the singleton Frame Manager object. There are potentially several different types of Frame objects in the system, all of which can make up one or more applications. The Frame Window objects by themselves are empty shells, which supply the resizable windows frame, menu bar and toolbar. The substance of the frame window is added later and discussed in the Extending the Framework section. The following sections describe the various Frame scenarios that could be encountered in Metamail applications.

Single Frame Window Creation

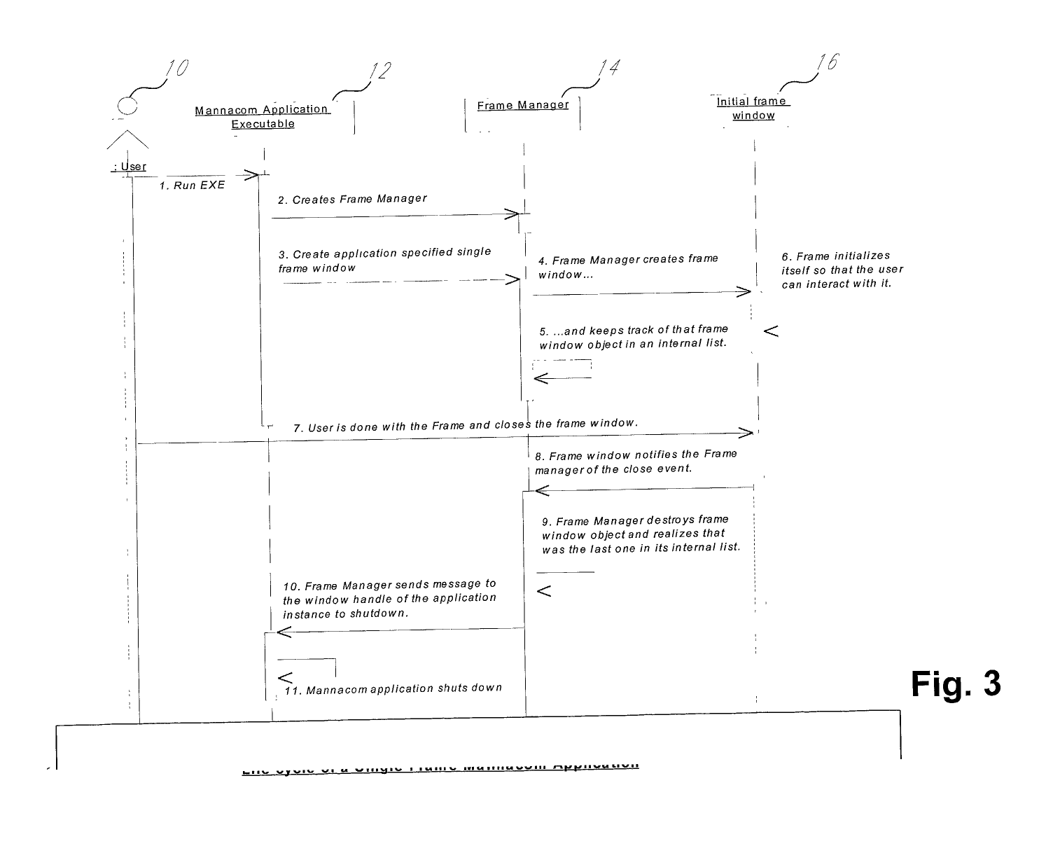

The simplest example of an application scenario involves the single Frame Window. Referring to FIG. 3, there is illustrated in a dynamic diagram, a user launching a Metamail application and a single frame is created and presented to that user. The Frame Manager 14 keeps track of all the frame window objects an application has open (in this case, the single one) and is notified if that frame window 16 is closed by the user 10. The Frame Manager 14 manages the frames it creates by maintaining them within an internal list. The notification system between the Frames 16 and the Frame Manager 14 are handled by a simple advise-sink mechanism. An important requirement of the Frame Manager 14 can be seen in step (10) of the FIG. 3. Since no single frame window 14 represents the main application, the Frame Manager's shutdown notification message needs to be sent to a physical window somewhere in order for the application instance to close. Thus, a Metamail application must maintain an invisible window and pass that window handle to the Frame Manager upon the Frame Manager's initialization.

Multiple Frame Window Creation

The Frame Manager 14 can handle a Metamail application 12 that employs multiple frame windows in its system much in the same way as a single-framed application. The difference is only in the number of frames the Frame Manager 14 must manage. As a singleton object in the system, the Frame Manager 14 can receive requests to launch frames from the application instance 12 itself or any other objects created within that applications process. For example, a Metamail application may launch an initial frame 16 through which an end user can launch additional flavours of frame windows. The Polaris application is such an example.

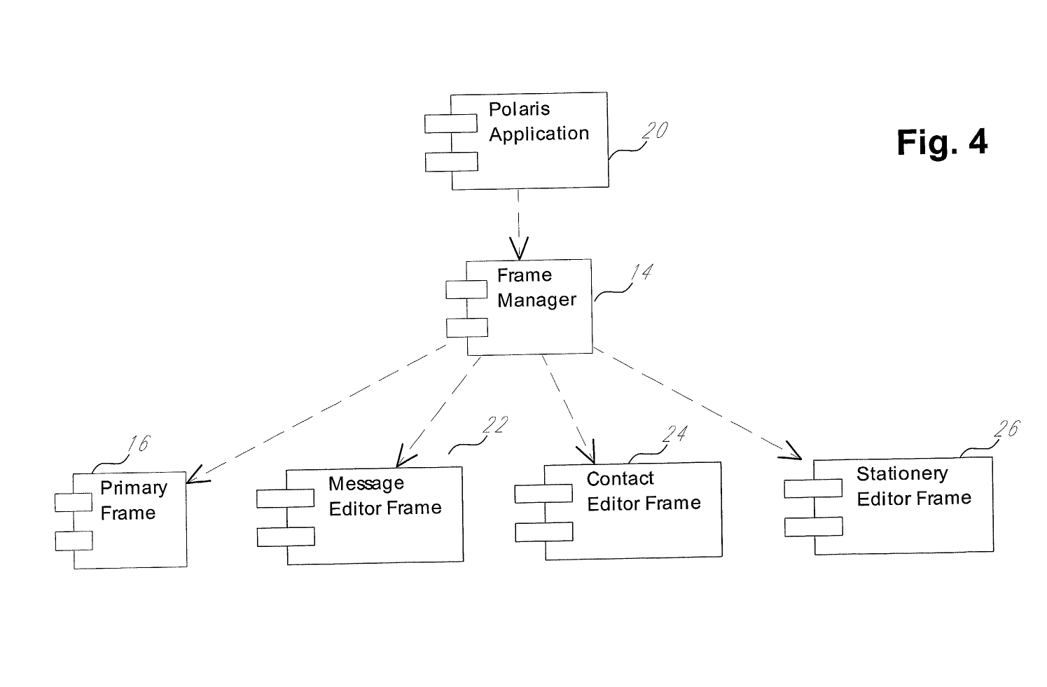

Referring to FIG. 4 there is illustrated in a block diagram an exemplary relationship between application, frame manager and various frame windows. The Polaris application 20 instantiates the Frame Manager 14 that instantiates the primary frame window 16. In Polaris, a user is presented with the Primary Frame window 16, through which the user can select and open multiple messages. At this stage, a request is made to the Frame Manager (through its interface) to launch the frames associated with these messages. For example a message editor frame 18, a contact editor frame 20 and a stationary editor frame 22. The Frame Manager 14 creates and maintains a watch over the life cycles of those frames in the same way as in the single frame scenario discussed in the previous section.

Regardless of how many objects make a frame creation request, all frame windows in the Metamail architecture are the responsibility of the Frame Manager 14. It is solely responsible for the creation and destruction of Frame Windows 16-22 and this dependency is shown FIG. 4 for the Polaris application case.

Single Instance Frames

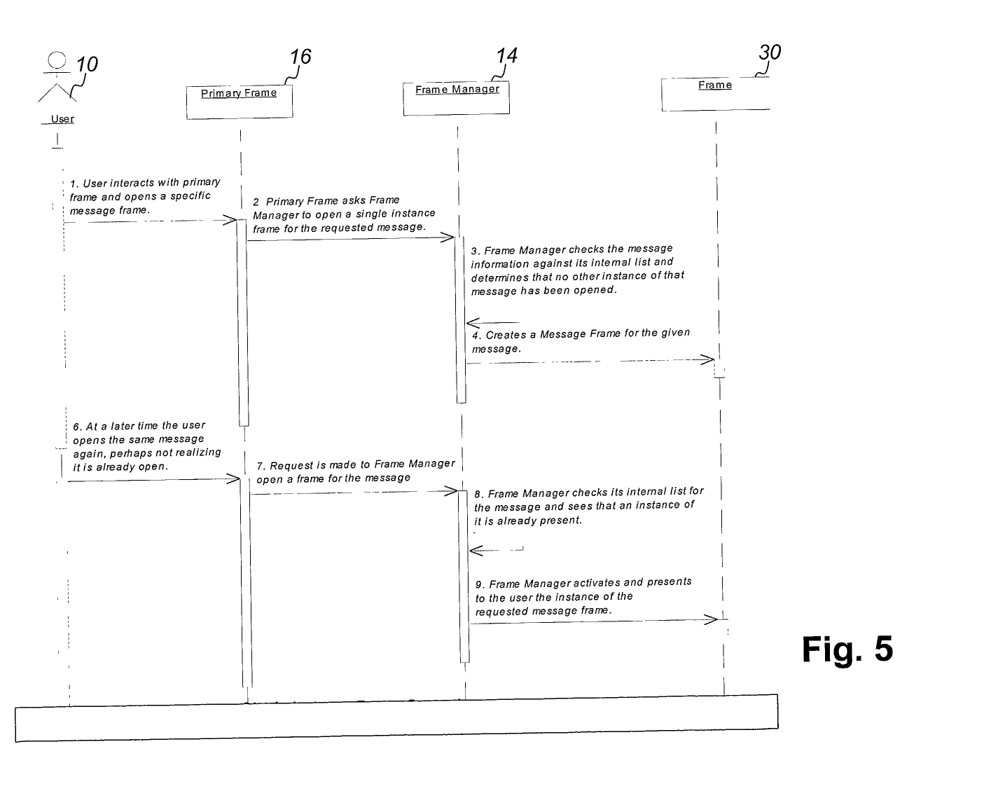

Referring to FIG. 5 there is illustrated in a dynamic diagram the management of a single instance frame. For more technical information on how to create a single instance frame and the format of the unique identifiers, see the Frame Manager overview section. In FIG. 5 a user 10 opens a specific message by interacting with the primary frame 16 and as a result a single instance frame 30 is opened at (4). If the user 10 subsequently opens the same message, the Frame Manager at (8) and (9) present the user with the single instance frame 30.

On occasion a Metamail application requires the functionality of re-activating a frame should a request be made by the user to open a new frame window with the same identifier. This behaviour can be seen in applications like Outlook and Polaris where a user cannot open the same mail message twice, or within the MDI confines of Word where an open document is activated if the user tries to open it again. Although some Metamail applications will allow a single document to be opened multiple times, some may chose to follow this “single instance” behaviour. As a result one of the functional requirements of the Frame Manager 14 is to allow an application instance or any object to create a “single instance” of a frame window based on some unique identifier.

Extending the Framework

So far the discussion has touched only on two of the major components in the Metamail Framework Architecture, namely Applications and Frames. The previous section, Initializing the Framework, discussed how Metamail applications used the Frame Manager to effectively create the necessary Frame windows. However, these Frame windows do not yet provide the necessary substance to make a Metamail application appear complete to the end user. The Frame windows themselves are merely empty UI shells that are begging to be filled or “extended”. The following sections describe the role of Extensions in the Metamail Architecture.

Extensions extend Frame windows on two levels. At a core level, an extension can provide a Frame with its basic identity by encapsulating the management and persistence of that frame's data in a single object. To the frame that object represents the document (similar to MFC notion of a document object) and is consequently known as the Document Extension. At a secondary level, an extension can provide a frame with autonomous functionality, such as providing a user with a command to browse their hard drive or view the system registry. More often such an extension is used to extend and enhance the frame's document by perform functions on that encapsulated data (e.g. a frame window that encapsulates a rich text document extension is enhanced by a Format extension that allows the user to change font information). These extensions are known as Enhancement Extensions. Extensions extend Frame Windows by inserting themselves into the user interface (toolbars /menus/ accelerators), giving users access to the extension's functionality. A Frame window builds itself by enumerating through all the extensions that are meant to extend it (specified in registry settings) and incorporating the extensions' functionality within itself. In order to do this each Frame Window creates an

Extension Manager

The Extension Manager builds the Frame Window's toolbars and menus and manages the routing of those commands to the appropriate extensions. The following sections illustrate this extension construction and their role in the framework in greater detail.

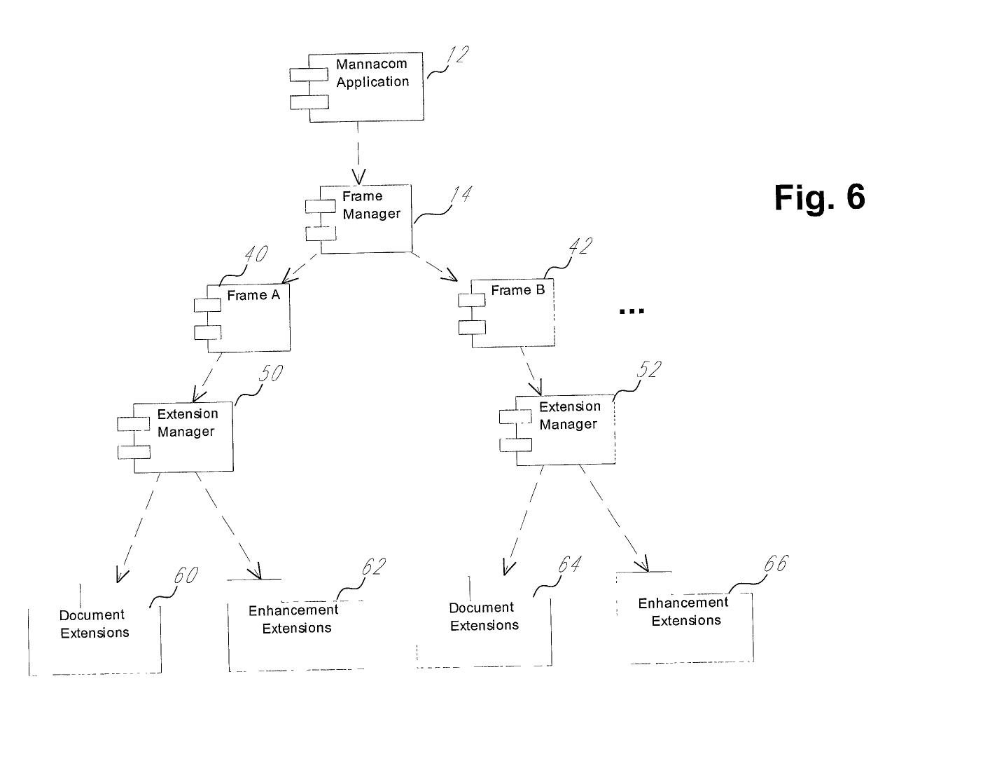

Referring to FIG. 6 there is illustrated a dependency diagram showing the Extension Manager's place in a Metamail application with two frames launched. The Manancom application 10 instantiates and controls the Frame Manager 14. The Frame Manager controls two frame windows 40 and 42 with extension managers 50 and 52, respectively. Extension Manager 50 has documents extensions 60 and enhancement extensions 62. Extension Manager 52 has documents extensions 64 and enhancement extensions 66.

Extension Manager provides the following functions:

Extension Creation: Describes the steps taken by the Extension Manager to create extensions.

Integrating Extensions within the Frame UI: Describes the steps taken by the Extension Manager in integrating all of the extensions' UI elements within that of the Frame.

Document Handshaking: This section describes how the Extension Manager connects the Enhancement Extensions to the Document Extension. It also touches on cases where a Frame may have more than one Doc.

Extension Command Routing: Describes how the Extension Manager routes specific commands to the appropriate extensions.

Documents

Extending the Document with Enhancement Extensions

The Extension Manager is a COM object that provides the Frame with the service of constructing and integrating all of its extensions. There is one Extension Manager per Frame. In the next few sections we will outline some of the Extension Manager's main responsibilities.

Extension Creation

In order for the Frame's Extension Manager to create the appropriate extensions, it must first find a list of those extensions associated with the particular Frame. The location of this list is under a Metamail key in the system registry. The Extension Manager uses the CLSID of the owner Frame to locate that Frame's extension information under the Metamail key in the registry (the interface details are discussed in technical detail in the Extension Manager reference section). For example, the registry may appear as follows:

[. . .]\

\Frames

\CLSID of Frame

\[Extension Info]
\ CLSID of Document Extension
\ CLSID of Enhancement Extension 1
\ CLSID of Enhancement Extension 2
\. . .

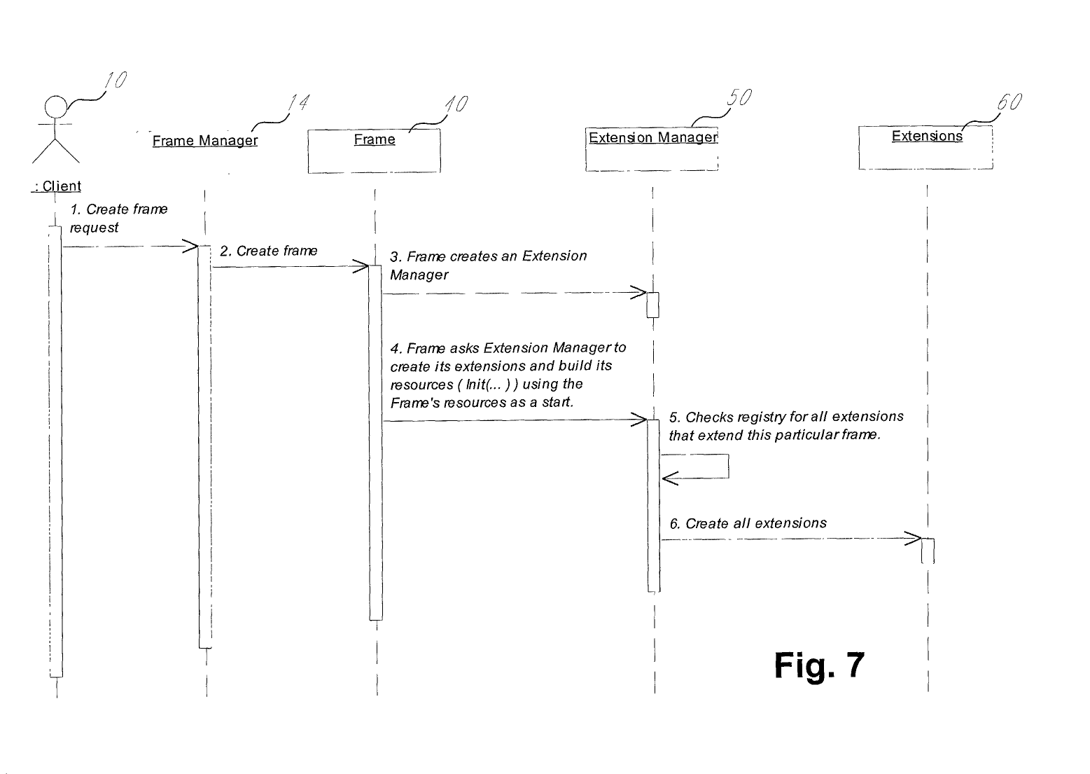

Once the list is located, the Extension Manager 50 enumerates through and instantiates all of the Extensions 60 that are extending the Frame 40. The Extension Manager 50 is ultimately responsible for all the Extension objects it creates and is responsible for handling their destruction. This is illustrated in FIG. 7 the dynamic diagram.

Integrating Extensions within the Frame UI

Now that each of the Frame's extensions have been created, the Extension Manager 50 proceeds with the integration of the extensions within the Frame's user interface. In order for an extension to extend the Frame 40 it must supply the end user 10 with access to its features through user interface components. These components include the menu, toolbar and accelerators (although there is no visible UI, an accelerator key still provides access to the extension's feature).

Given the Frame's menu/toolbar/accelerator resources, again through an Extension Manager initialization interface, the Extension Manager 50 begins to merge them with the resources of each extension in priority order: Frame, Document Extension, and then Enhancement Extensions. This request is made of the Extensions through the standard Extension interface. The rules governing this resource merge, including conflict resolution of command IDs, is described in detail in the Structured Resource Insertion section. The final set of resources is handed back to the Frame for use within its UI.

When dealing with Metamail applications that allow the user to open numerous instances of a particular Frame object (which happens quite frequently in Polaris whereby a user is allowed to open several messages at once), we must find some means of optimizing the Extension Manager's resource merging. The Extension Manager constructs a Frame's resources based on the class of Frame rather than the instance of a Frame. Each class of Frame is extended by a set of extensions, a set listed in the registry. Thus, if an Extension Manager is constructing the resources of a particular Frame instance it should cache those resources so another similar Frame/Extension Manager pair can use it. The location of this cache can logically fall to the Resource Provider. The Resource Provider supplies an interface so that anyone in the system can use it as a resource cache.

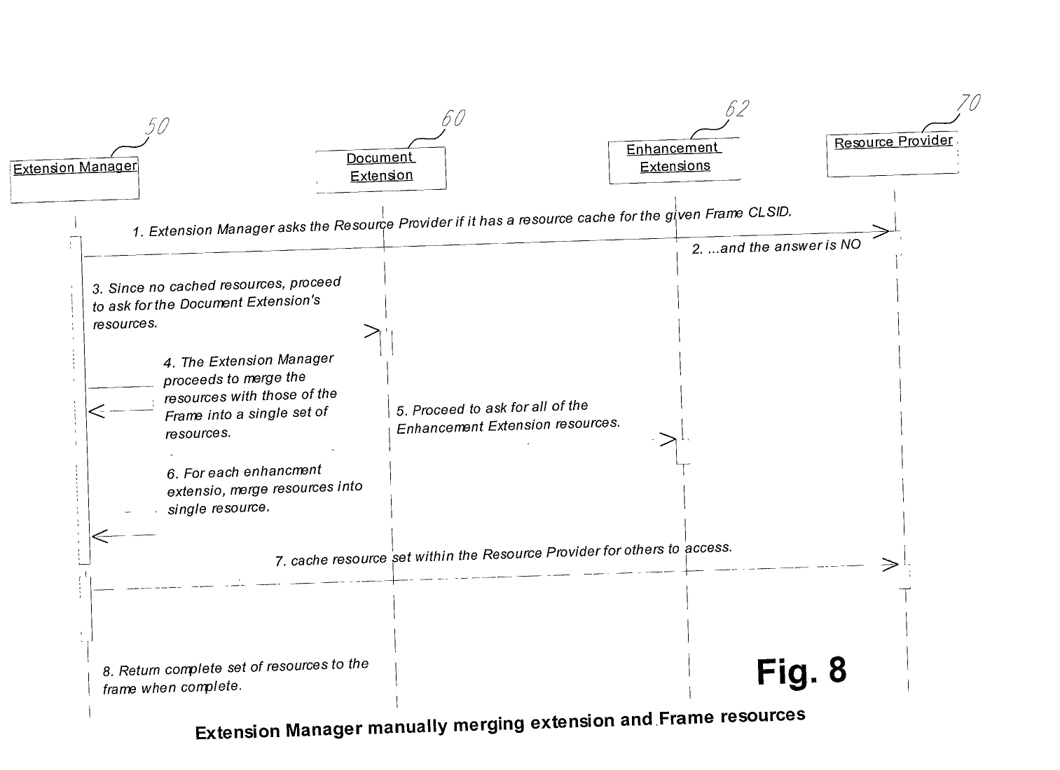

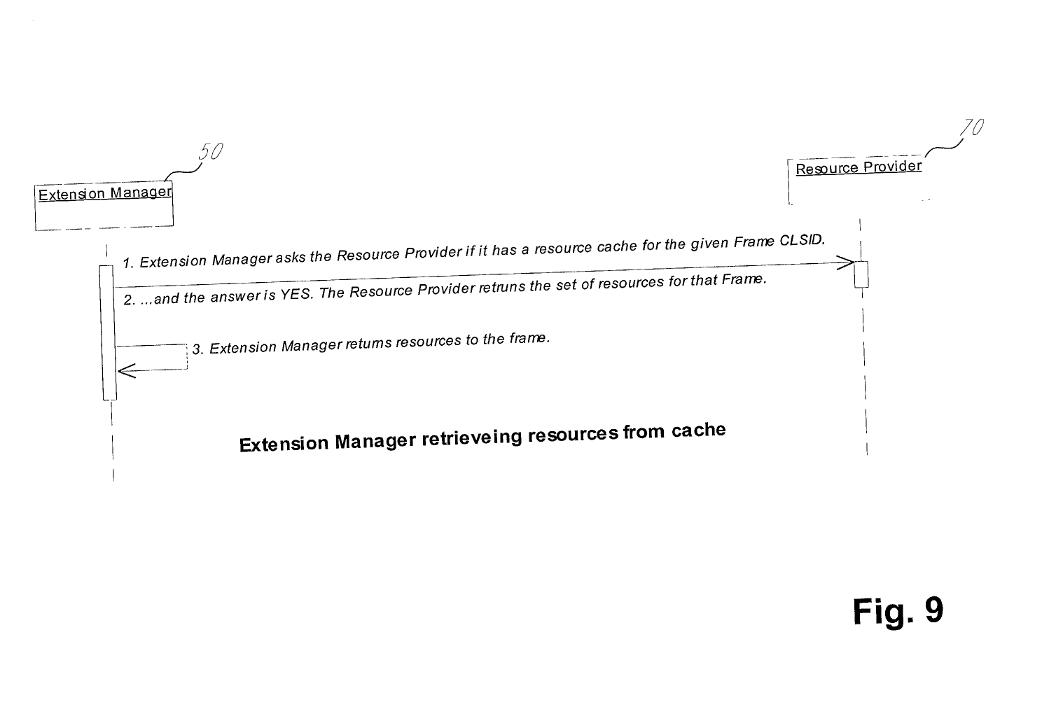

As shown in the dynamic diagrams of FIGS. 8 and 9, an Extension Manager 50 should first check for the resource set for the given frame within the Resource Provider cache 70. If there is none to be found, the Extension Manager proceeds to create the merged resources and upon completion, sets the resource set into the cache. Should another similar Frame come along, its Extension Manager can retrieve the cached resources and save itself the manual work of recreating them.

Handshaking

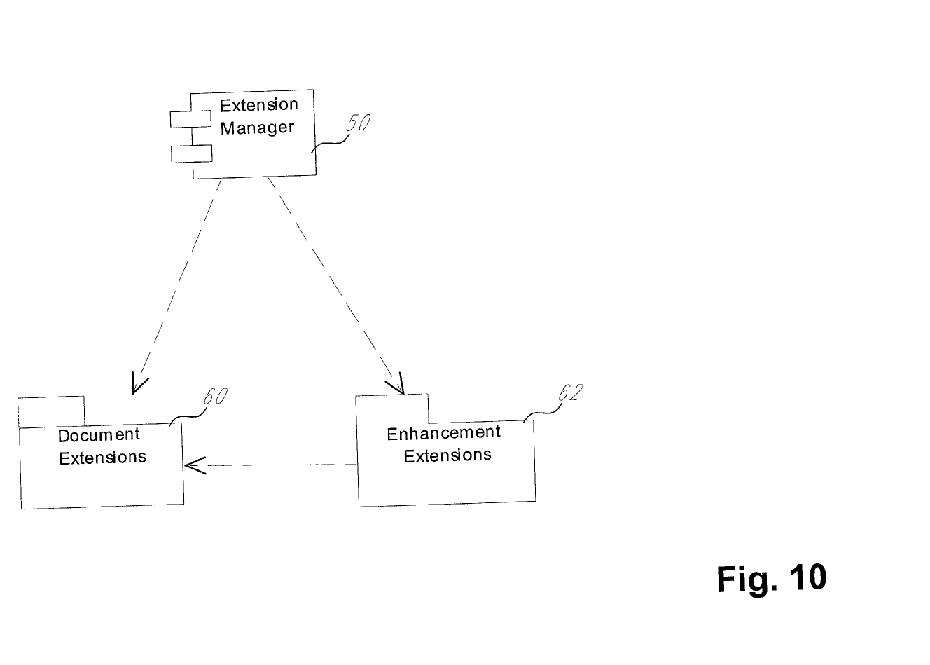

Referring to FIG. 10 there is illustrated in a block diagram the extension manager's handshaking mechanism. In order for an Enhancement Extension 62 to extend the Frame's document, the Extension Manager 50 must provide a handshaking mechanism between all enhancements and their document. Once this handshaking is complete, the Enhancement Extensions 62 can query specific interfaces on the Document Extension 60 in order to interact with the document data. This interaction is described in further detail in the Extending the Document with Enhancement Extensions section.

The handshaking mechanism begins with the Extension Manager 50 instantiating the Document of a Frame and then proceeds to the creation of the Enhancement Extensions 62. As it creates each enhancement, it provides them with an interface pointer to the Document, which they hold on to for later use.

Extension Command Routing

When the process of merging the resources begins, the Extension Manager 50 must be able to handle potential conflicts between extensions and the Frame's own commands (such as File-Close or Help). In order to avoid messy conflicts, the Extension Manager 50 re-maps all of the extension commands into a command map of its own.

As the Extension Manager 50 loops through each of the extensions' resources it follows these steps for each extension command encountered:

Given an extension command ID, store the extension pointer and original command ID within an internal lookup table.

Assign that extension command a new and unique ID

Insert that new command into the final resource set.

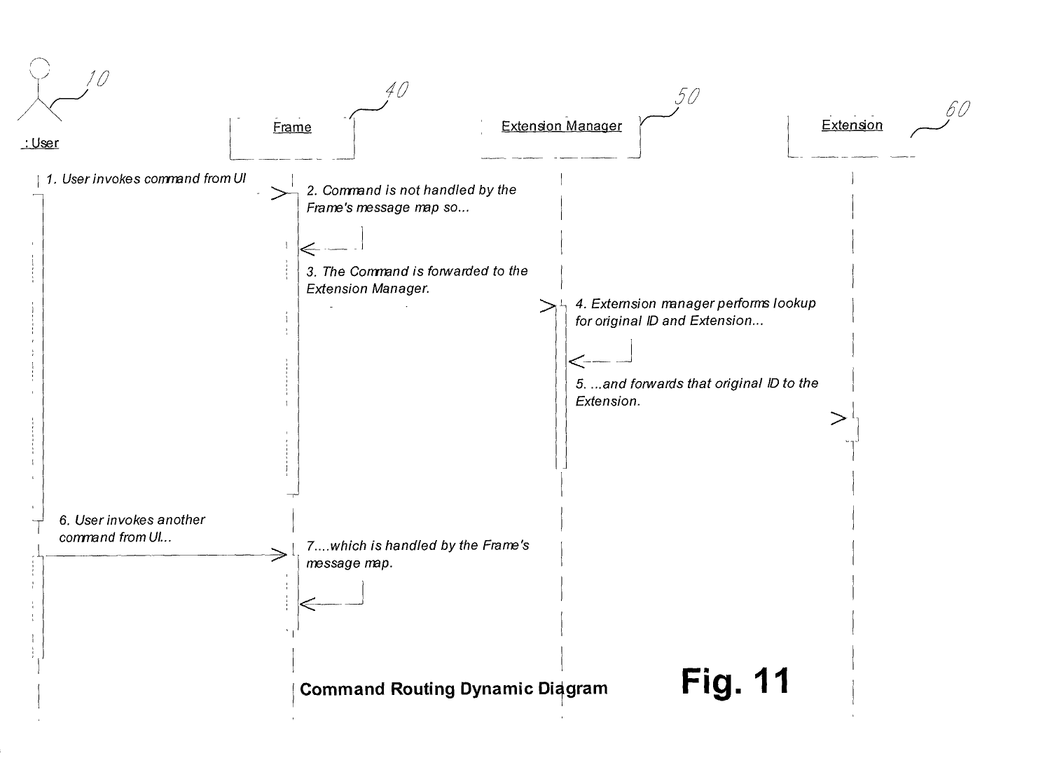

Thus, when the user invokes that command from within the Frame 40 through the menu, toolbar or accelerator, the command is routed through the Extension Manager 50. The command is then translated through the Extension Manager's internal map and forwards the original command ID to the extension. This command routing procedure allows the Frame 40 to simply keep its own message map and IDs since the Extension Manager 50 only translates extension commands. Any command that is not caught by the Frame's message map falls through to the Extension Manager's map. In FIG. 11 a dynamic diagram illustrates the command routing procedure.

Documents

As previously mentioned the Document or Doc represents the core of the Frame. The Doc provides the majority of the functionality perceived by the user. Since a Doc is an encapsulation of a data type, it must provide the basic means to manipulate that data. When designing a Doc one must be able to categorize all basic functionality within it and design Enhancement Extensions to handle any special data handling. To facilitate the special handling, a handshaking mechanism (described in the earlier section) is utilized to allow Enhancement Extensions access to the document data. This handshaking mechanism gets complicated when dealing with multiple documents per Frame, an allowable scenario in the Metamail architecture.

Usually the relationship between Frame and Document is 1:1. However, on occasion a Frame may actually manage more than one Document Extension at a time (e.g. Polaris' Primary Frame manages 3 documents). This management of multiple documents is left largely up to the Frame itself, however it does use some functionality provided by the Extension Manager 50. The first sign of help in managing multiple documents can be found within the registry (See registry hierarchy for an accurate application view of the structure):

[Metamail]\

\Frames

\Initial Frame

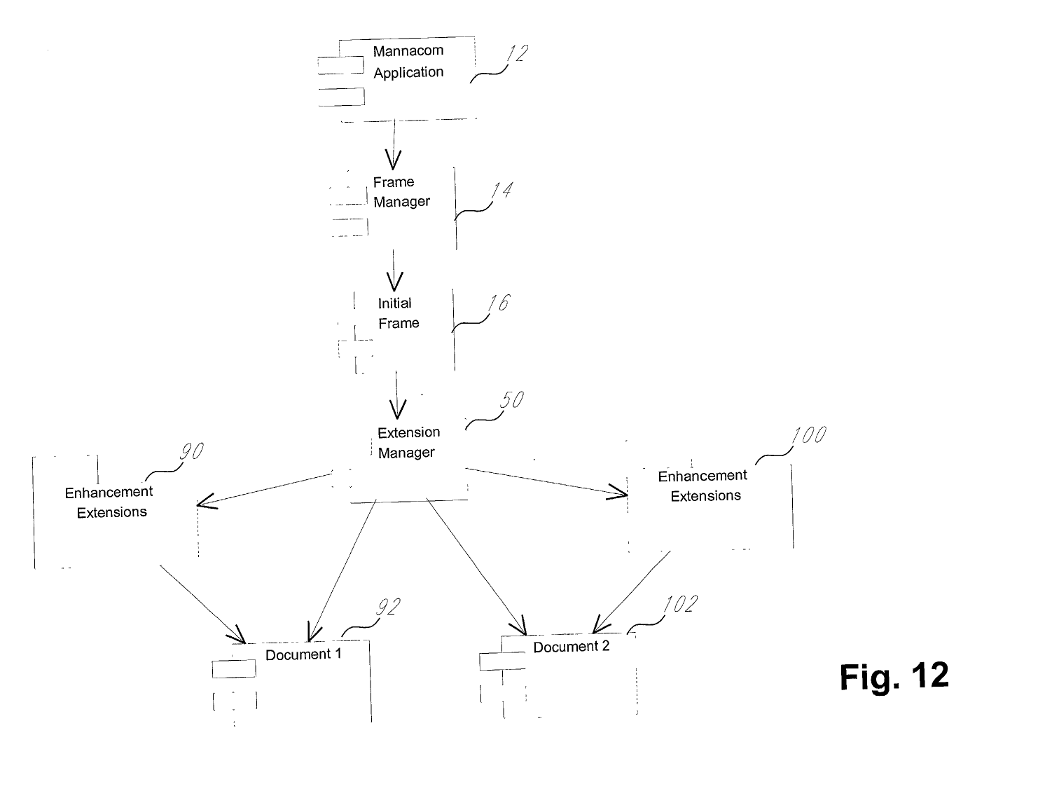

\[Extension Info]
\Doc1\[Enhancement Ext. List]
\Doc2\[Enhancement Ext. List]

where the Frame 16 managing multiple documents has its enhancement extension list broken up by document. This allows the Extension Manager 50 to handshake the Enhancement Extensions 90 and 100 it creates with their associated documents 92 and 102. The second sign of help comes in the form of the Extension Manager 50 returning separate merged resources for each document. This is done through the Extension Manager's interface whereby it returns an enumeration of resources sets, one per document. What the Frame 16 does with the resources (i.e. how it switches between them, etc . . . ) is the Frame designer's choice. The relationships are shown in FIG. 12.

Extending the Document with Enhancement Extensions

Once the document handshaking has been completed between the Extensions and Document, the Extensions need to access the document data through specific interfaces. These interfaces are defined by the Document designer with the intent of exposing as much data as possible (or is allowable) to other extensions. A Doc designer gathers such information by examining existing extensions and anticipating future ones.

For example, a Text Doc may expose basic interfaces to retrieve selected text or the complete text stream from the document and allow modifications on that text. The designer may have used the needs of an existing Enhancement Extension, such as the Spell Checker, to determine what interfaces to expose from the Doc. With this basic set of interfaces established, a future Enhancement Extension, that gets the selected or complete text and converts it all into French, can be written by a 3rd party developer. Similarly, an Image Doc may give Enhancement Extensions access to the mask drawn by the end user so that future paint effects extensions can be written.

What is claimed is:

1. A method of realistically displaying and interacting with electronic files comprising the steps of:
separating an electronic file into a plurality of sub-elements;
instantiating a frame manager object for controlling user interface frame windows; and
generating a primary frame for displaying an initial sub-element.

2. A method as claimed in claim 1 further comprising the step of responsive to an appropriate user action, generating a secondary frame for another sub-element.

3. A method as claimed in claim 1 wherein the frame manager object includes a list of frames generated.

4. A method as claimed in claim 1 wherein the primary frame is singular.

5. A method as claimed in claim 1 wherein the step of generating the primary frame includes the step of generating an invisible frame.

6. A method as claimed in claim 4 wherein the invisible frame is used to control closing an application using the frame manager object.

7. A method as claimed in claim 2 wherein the primary frame includes a user selectable object.

8. A method as claimed in claim 6 wherein the appropriate user action includes selecting the user selectable object.

9. A method as claimed in claim 2 wherein the primary frame includes a plurality of user selectable object.

10. A method as claimed in claim 8 wherein the appropriate user action includes selecting one of the plurality user selectable objects.

11. A software architecture for graphically displaying electronic files comprising:
an application executable;
a frame manager object instantiatable by the application executable for managing all frame windows needed by the application; and
an initial frame window for displaying a sub-element of a file.

12. A software architecture as claimed in claim 11 wherein the initial frame window controls creation and destruction of further frame windows.

13. A software architecture as claimed in claim 13 wherein further frame windows are each for displaying a sub-element of a file.

14. A software architecture as claimed in claim 13 wherein each further frame window includes an extension manager.

15. A software architecture as claimed in claim 14 wherein the extension manager controls enhancement extensions.

16. A software architecture as claimed in claim 14 wherein the extension manager controls document extensions.
